(19) United States
(12) Patent Application Publication
(10) Pub. No.: US 2002/0117543 A1
(43) Pub. Date: Aug. 29, 2002

(54) Access control system

(75) Inventors: Wolfram Kocznar, Innsbruck (AT); Rudolf Golser, Hallein-Rif (AT); Josef Fischer, Hallein-Rif (AT); Hans-Peter Heller, Faistenau (AT)

Correspondence Address: HENRY M FEIEREISEN, 350 FIFTH AVENUE, SUITE 3220, NEW YORK, NY, 10118, US

(73) Assignee: TEAMAXESS TICKETING GMBH, Koppl (AT)

(21) Appl. No.: 10/103,148

(22) Filed: Mar. 21, 2002

Related U.S. Application Data
(63) Continuation of application No. PCT/AT00/00253, filed on Sep. 22, 2000.

(30) Foreign Application Priority Data
Sep. 22, 1999 (AT) GM 650/99

(51) Int. Cl. G06K 5/00

(52) U.S. Cl. 235/380

(57) ABSTRACT

An access control system includes at least two access routes (2, 2′) which can be blocked with controllable barriers. The access control system further includes an antenna (A1, A2) associated with each of the access routes, and a control device (1) for evaluating access authorization cards, e.g. RFID transponders, which operate without making galvanic contact. Each antenna (A1, A2) is connected to a corresponding transmit/receive unit (13, 14), and the terminals of the antennae (A1, A2) associated with the access routes (2, 2′) are connected to a deactivation device.

### CROSS-REFERENCES TO RELATED APPLICATIONS

This application is a continuation of prior filed copending PCT International application no. PCT/AT00/00253, filed Sep. 22, 2000.

This application claims the priority of Austrian Patent Application Serial No. GM 650/99, filed Sep. 22, 1999, pursuant to 35 U.S.C. 119(a)-(d), the subject matter of which is incorporated herein by reference.

### BACKGROUND OF THE INVENTION

The present invention relates to an access control system with at least two access routes that can preferably be blocked with controllable barriers, with an antenna being allocated to each of the access routes, and a control device for evaluating access authorization cards, e.g. RFID transponders, which operate without making galvanic contact. Each antenna is connected to a corresponding transmit/receive unit.

Systems for access control are known, for example, for use in aerial tramways and lifts, but can also be used in many other applications. Typically, an automatic ticket reader reads the access authorization cards (ticket) of the person passing through and blocks access in most cases by a turnstile or permits access through the turnstile, when a check of the authorization is validated.

In modern systems of this type, so-called RFID transponders are used, whose function is described in more detail, for example, in the RFID handbook (1998 Carl Hauser Verlag, München Wien). All the transponders are implemented as electronic data carriers embedded in a plastic card having a credit card format. Energy is supplied to the data carrier and data is exchanged between the data carrier and a reading device not through a galvanic contact, as is known from conventional chip cards, but by using magnetic or electromagnetic fields. An RFID transponder includes an electronic microchip and a coupling element, such as a coil or an antenna, through which the energy required for operating the transponder is received, which in turn is transmitted by the reading device. The data exchange can also be implemented by attenuating the electromagnetic field radiated by the reading device. Many different embodiments of such RFID (radio frequency identification) systems are known that operate in different radio frequency ranges or in the microwave range.

An electronic ticket which is commonly in the form of a card, stores the authorization data in an EEPROM. Conventional RFID transponders operate in a carrier frequency range of 125 kHz as well as in a frequency range of 13.56 MHz. The higher frequency RFID transponders are superior in many aspects to those operating at lower frequencies, in particular with respect to the reading speed. The data stored in the transponder are read and can optionally be changed, when the RFID transponder enters the electromagnetic field of a corresponding access terminal. The access control system employs an antenna in form of a conducting loop which is connected to a transmit/receive electronics, and a turnstile, both of which are associated with a respective access route. Such control systems can also be used without a turnstile or barrier, for example, for gathering statistical information regarding the passages or to optically indicate the respective access authorization.

Since the antennas are arranged with a relatively small separation therebetween, mutual interference can occur, which can cause the system to malfunction. This can manifest itself, for example, in that one access route is opened without providing an access authorization card for that route.

It would therefore be desirable and advantageous to provide an improved access control system to obviate prior art shortcomings and to eliminate such mutual interference and the failures resulting therefrom.

### SUMMARY OF THE INVENTION

According to one aspect of the present invention, an access control system includes at least two access routes which can be blocked with controllable barriers, an antenna being allocated to each of said access routes, and a control device for evaluating access authorization cards, e.g. RFID transponders, which operate without making contact, wherein each antenna is connected to a transmit/receive unit, wherein the terminals of the antennas associated with the access routes are connected to a controllable deactivation device.

The present invention resolves prior art problems by connecting the terminals of the antennas associated with the access routes to a controllable deactivation device. In this way, mutual interference between several antennas and/or access routes is eliminated with the access control system of the invention, because the deactivation device places those antennas which can receive an interfering signal transmitted by another antenna in an inactive state.

According to another feature of the invention, the deactivation device can be formed by a device that short-circuits the antenna. By short-circuiting one or more antennas, the reception of an interference signal in these antennas is prevented.

According to another feature of the invention, the length of the connection between the transmit/receive electronics can be selected so that a short-circuit in one of the antennas corresponds to an open circuit at the terminals of the respective transmit/receive electronics, wherein preferably the length of the connecting line corresponds to one quarter of the wavelength of the carrier frequency of the signal transmitted by the transmit/receive electronics. In this way, the antenna that is connected by a short-circuit can remain connected to a transmit/receive unit without overloading the unit.

To provide a simple electronic control, the device for short-circuiting can be formed of two back-to-back connected diodes, which are connected to the terminals of the antenna. A control unit is connected at the connection point which is capable of applying a positive auxiliary voltage or a negative auxiliary voltage or ground to the connection point.

To prevent the electronic control of the diodes from affecting the antenna signal, according to another embodiment of the invention, the positive auxiliary voltage can be selected to be greater than the idle voltage of the antenna signal.

According to another feature of the invention, the deactivation device can be formed by a device that attenuates and/or detunes the antenna. In this way, the antennas that are not ready for the actual transmission or reception are prevented from receiving interfering signals.

According to another feature of the invention, each of the antennas can include a conducting loop which together with an oscillating circuit capacitance forms a parallel-resonant circuit which is tuned to the carrier frequency of the signal transmitted by the transmit/receive electronics, wherein this oscillating circuit can be detuned or short-circuited through at least one electronic switch. Detuning the oscillating circuit makes it easy to attenuate and thereby deactivate the antenna.

In a modification of the invention, scaling capacitances can be provided which can be connected in parallel with the oscillating circuit capacitance through relay contacts or the electronic switch. The corresponding antenna oscillating circuit can be detuned by activating the contacts and/or the electronic switch.

In a preferred design for separating the antennas, the control device can be located between two adjacent access routes, with the antennas located on opposite sides of these access routes.

According to another feature of the invention, the degree of detuning that can be achieved can be determined by providing an auxiliary coil and an evaluation electronics connected thereto, wherein the maximal voltage at the antenna is measured as a function of detuning of the antenna oscillating circuit.

The invention is also directed to a logic program for controlling an access control system, wherein at least two access routes that can be blocked by controllable barriers, can be monitored using a corresponding antenna for each route and a transmit/receive electronics, wherein the access route is opened upon detection of a contactless access authorization card, for example in form of an RFID transponder.

It would also be advantageous and desirable to eliminate mutual interference between the antennas.

According to another aspect of the present invention, only one antenna is sequentially connected with its associated transmit/receive electronics, and that the remaining antennas are short-circuited or attenuated and/or detuned. With this arrangement, all other antennas except for the currently activated antenna are deactivated, thereby preventing an interference signal to occur in these remaining antennas, by which the access authorization control could cause false results in other access routes.

According to another feature of the invention, each of the antennas can be connected in rapid succession with their respective transmit/receive electronics and when an access authorization card is detected in the reception range of one of the antennas, the connection between this antenna is maintained until the respective transmit/receive electronics has completed a reading transaction relating to this access card. This can prevent errors in recognizing an authorization card.

According to another feature of the invention, each antenna can be excluded from the sequential activation of the antennas until a completed reading transaction has caused a following action, such as a passage through a turnstile. This further increases the reliability of the access control system according to the invention.

The invention also relates to an access control system with a control device for evaluating contactless access authorization cards, such as RFID transponders. The control device is connected to at least one antenna for detecting the access authorization cards, wherein the at least one antenna has a conducting loop which together with an oscillating circuit capacitance forms an oscillating circuit, whose resonance frequency is tuned to the carrier frequency of a transmitter/receiver circuit for the RFID transponder.

It would be desirable and advantageous to enable automatic adjustment of the value of the oscillating circuit capacitance for tuning or detuning the antenna oscillating circuit.

According to still another aspect of the present invention, the oscillating circuit capacitance is composed of several scaling capacitances, and that scaling capacitances can be stepwise connected to or disconnected from the oscillating circuit capacitance by controlled switching elements. In this way, the antenna can be affected by changing the oscillating circuit capacitance so that the antenna is either in an active state or in an inactive state.

According to another feature of the invention, the scaling capacitances that can be connected or disconnected, can be selectively connected via diodes to a positive or a negative auxiliary voltage and thereby connected to or disconnected from the oscillating circuit capacitance.

The antenna is tuned by measuring the antenna voltage as a function of the scaling capacitances which are added stepwise, until the antenna voltage reaches a maximum value.

Moreover, respective pairs of the scaling capacitances that can be connected or disconnected, can be connected to or disconnected from the oscillating circuit capacitance via back-to-back connected diodes and a negative and a positive auxiliary voltage. This arrangement provides a simple circuit for changing the oscillating circuit capacitance.

According to another feature of the invention, the two diodes may be connected at their respective cathodes, whereas the respective anodes are connected with one of two scaling capacitances of the pair that can be connected or disconnected. The connection point of the diodes can be connected to a switching element implemented as a change-over switch which is capable of connecting the connection point of the diodes either to the positive or negative auxiliary voltage. This enables connection or disconnection of the scaling capacitances by controlling the potential at the connection point of the back-to-back diodes.

To effectively AC-decouple the anodes of the diodes from ground potential, each of the anodes of the two scaling capacitances that can be connected or disconnected can be connected to ground via an inductance, with the center tap of the conductor loop of the antenna being connected to ground.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic top view of an embodiment of the access control system according to the invention;

FIG. 2 is a schematic side view of the embodiment depicted in FIG. 1;

FIG. 3 is an embodiment of a circuit diagram for the control system according to the invention;

FIG. 4 is another embodiment of a circuit diagram for the control system according to the invention; and

FIG. 5 is yet another embodiment of a circuit diagram for the control system according to the invention.

### DETAILED DESCRIPTION OF PREFERRED EMBODIMENTS

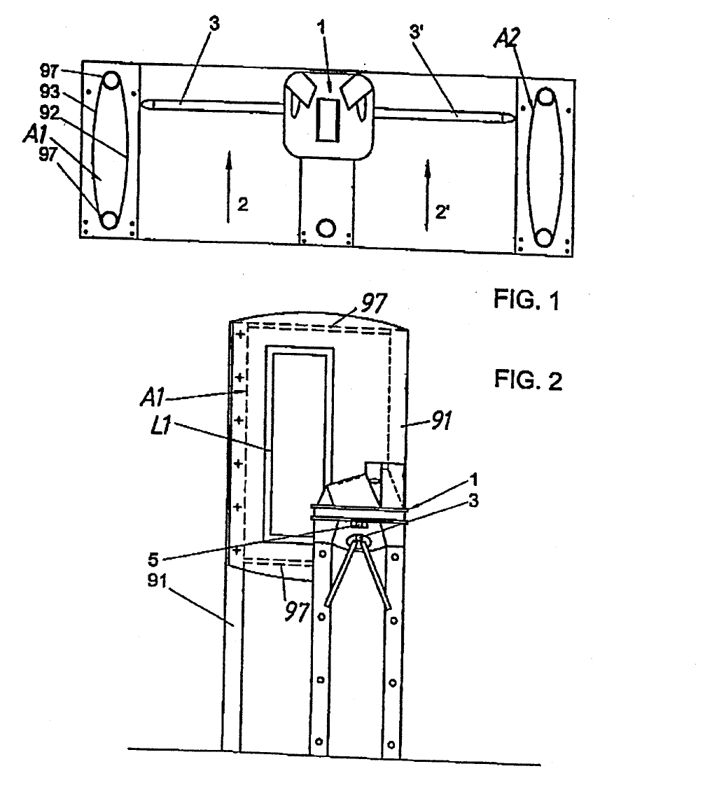

The embodiment depicted in FIGS. 1 and 2 illustrates an access control system according to the invention in use, for example, at ski resorts. However, such system can also used for other applications, for example for auditoriums, sports stadiums, swimming pools, etc. Moreover, the term access card or ticket is intended to refer to any type of ID card, ticket, card of value and the like.

FIG. 1 shows two adjacent access routes 2 and 2′ which in the present example have a width between 45 cm and 65 cm. A central control device 1, which includes the components for controlling to the access control system of the invention, is located in the center between the two access routes 2, 2′. The columnar housing which houses the control device 1, forms a dividing line between the access routes 2, 2′. Each access route 2, 2′ can be blocked by a turnstile 3, 3′ which is opened depending on the validity of the read access authorizations. The two outer boundaries of the access routes 2, 2′ are formed by frame-like structures which house the antennas A1, A2 associated with the access routes 2, 2′. The antennas are used for evaluating contactless access authorization cards, for example, contactless chip cards and/or RFID transponders. Each of the frame-like structures of the antennas A1, A2 consists, when viewed in the passage direction, of two parallel vertical pipes 91 which can be secured to the ground and adjustable in height, optionally through matching inner pipes, and which are connected by transverse rods 97. Plates 92 and 93 are attached on the two opposing sides of the frame formed by the vertical pipes 91 and the transverse rods 97. The plate 92 which is located towards the inside of the access route, is made, for example, of polycarbonate, but can also be made of another non-conducting material. Plate 93 located on the outside has a grid made of an electrically conducting material for shielding the fields produced by the antenna to the outside.

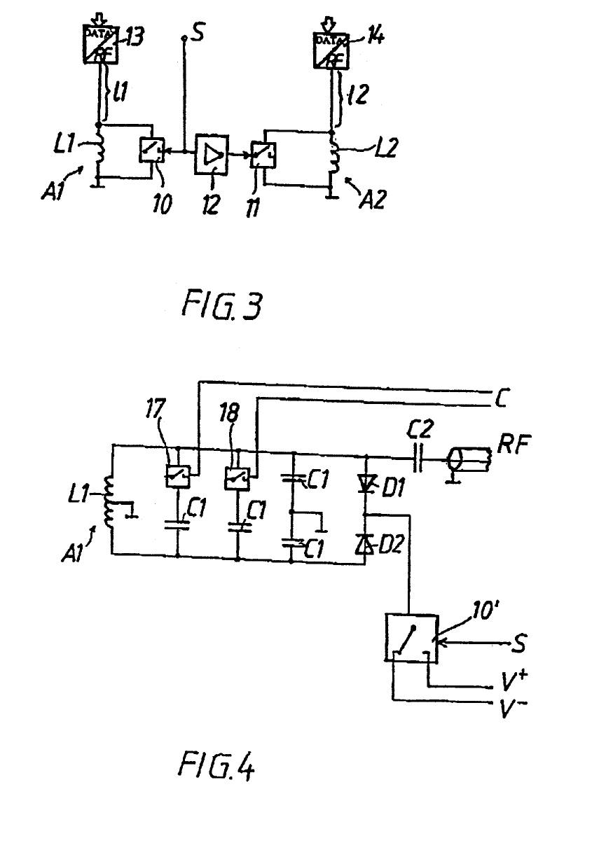

As shown in FIG. 3, each antenna A1, A2 is connected with a dedicated transmit/receive unit 13, 14.

Each of the two transmit/receive units 13, 14 for the antennas A1, A2 is in turn connected with a reading device (not shown) of the control device 1 for detecting the received signals and/or a decrease in the intensity of the transmitted signal. When the reading device recognizes a valid authorization in the reception area of the antennas A1, A2 which can be carried by a person present in the access route, the respective barrier 3, 3′ is automatically released and the authorized person can pass through the corresponding access route 2, 2′.

The illustrated arrangement of the antennas is particularly suited for admitting people, because the passage area is not narrowed, while still allowing detection of a single person. The invention can also be applied to more than two access routes, wherein an additional antenna and an additional transmit/receive unit are provided for each additional access route.

According to the invention, the terminals of the antennas A1, A2 associated with the access routes 2, 2′ are connected with a controllable deactivation device 10, 11.

Only one antenna A1, A2 at a time is sequentially connected to the transmit/receive electronics 13, 14, while the remaining antennas are either short-circuited or attenuated and/or detuned.

More particularly, each of the antennas A1, A2 can be connected in rapid succession with its associated transmit/receive electronics 13, 14. If an access authorization card is detected in the reception range of one of the antennas A1, A2, the connection of this antenna is maintained until the respective transmit/receive electronics 13, 14 and/or the associated reading device have completed a reading transaction related to the access card.

Each antenna A1, A2 can be excluded from the successive activation of the antennas A1, A2 until a completed reading transaction has resulted in a subsequent action, for example a passage through a turnstile.

FIG. 2 is a top view of the conducting loop L1 of the antenna A1 which is located shortly before the a barrier of a turnstile 3, as seen in the direction of passage. Also arranged in the access blocking plane is a light sensor 5 which automatically releases the turnstile when the respective person passes through after a valid access authorization has been read.

The arrangement and shape of the antennas A1, A2 depicted in FIGS. 1 and 2 is to be regarded as only one of many possible embodiments. For example, the antennas can also be located inside the housing of the control device 1.

In the circuit diagram depicted in FIG. 3, each of the transmit/receive units 13, 14 is connected via a respective line of a length l1 and l2 to a corresponding conducting loop L1, L2 of the antennas A1, A2.

The transmit/receive units 13, 14 produce an RF field with a carrier frequency of, for example, 13.56 MHz and send commands and data to RFID transponders located in the reception range. The basic operation of such systems is described, for example, in the reference cited above.

The lines of length 11 and 12 are implemented as coaxial cables, wherein the length is selected to correspond to a quarter of the wavelength of the carrier frequency of the signal transmitted by the transmit/receive electronics 13, 14. In this way, a short circuit in one of the antennas A1, A2 corresponds to an open circuit at the terminals of the respective transmit/receive electronics 13, 14.

The deactivation units in the embodiment of FIG. 3 are implemented as devices 10, 11, preferably as electronic switches, that short-circuit the antennas A1, A2.

The bases of the antennas A1, A2 are connected to these electronic switches 10, 11 which can be activated via a control input S that is connected directly to the switch 10 and via an inverter 12 to the switch 11. This control input S opens one of the switches 10, 11 while closing the other switch, so that always only one of the antennas A1, A2 is activated. During this time, the respective other antenna is short-circuited and thereby deactivated. This short circuit is transformed due to the length of the connected line l1, l2 into a open circuit at the corresponding transmit/receive unit 13, 14 and has therefore no effect on the unit 13, 14. As can be easily understood, an arbitrary number of antennas can be operated in this way by alternatingly short-circuiting the antennas. Because the other antennas, except for the active antenna, are short-circuited, the antennas cannot affect or mutually interfere with one another.

The antennas A1, A2 are activated and/or deactivated in rapid succession via the control input S. When a transponder is detected, the switching sequence is stopped are until the reading/writing process is completed. The corresponding antenna A1, A2 is reactivated only after the authorized person has passed through the lane.

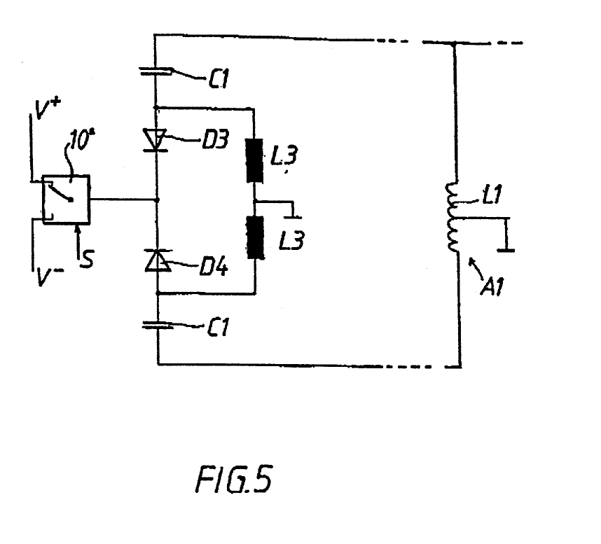

In an alternative embodiment of the invention, the deactivation device can be formed by a device that attenuates and/or detunes the antenna A1, A2. An embodiment of such a device for attenuating and/or detuning the antenna A1 is shown in FIG. 4. The antenna A1 can be tuned to a parallel-resonant circuit that is tuned to the carrier frequency of the transmit/receive unit 13 by two scaling capacitances C1 which can be connected by controlled switches 17, 18 to the conducting loop L1 of A1. The tuning operation can be automated by the two scaling capacitances C1 that can be connected or disconnected so as to prevent detuning during the operation, for example as a result of changed climatic conditions. The parallel-resonant circuit can also be detuned for the purpose of deactivating the antenna A1 by suitably addressing of the controlled switches 17, 18.

Two back-to-back diodes D1, D2 are connected to the terminals of the antenna A1 or to its conducting loop L1. The connection point of the diodes D1, D2 is connected to a control unit 10′ capable of applying a positive or negative auxiliary voltage V⁺, V⁻ or ground to the connection point. If a negative auxiliary voltage is applied to the connection point, then the conducting loop L1 is short-circuited and the antenna is deactivated. The antenna can then neither send signals to a transponder, nor can it be forced into oscillations by adjacent antennas.

If the diodes D1 and D2 are connected via the control unit 10′ to the positive auxiliary voltage V⁺, then the diodes are pre-biased in the reverse direction, so that the activated antenna A1 can oscillate freely. The positive auxiliary voltage is advantageously greater than the open circuit voltage of the antenna A1 so as not to impede an evaluation of the small information signals received from a transponder.

In another embodiment of the invention illustrated in FIG. 5, a capacitance of the oscillating circuit is comprised of several scaling capacitances C1, wherein the scaling capacitances C1 can be stepwise connected to or disconnected from the oscillating circuit capacitance by a controlled switching element 10″. The antenna oscillating circuit can be tuned or detuned by these scaling capacitances C1.

The scaling capacitances C1 can be connected selectively via diodes D3, D4 to a positive or negative auxiliary voltage and thereby connected to or disconnected from the total capacitance of the oscillating circuit.

In the embodiment illustrated in FIG. 5, two of the scaling capacitances C1 that can be connected or disconnected can be connected to or disconnected from the capacitance of the oscillating circuit (not shown) via the back-to-back diodes D3, D4 and application of a negative and a positive auxiliary voltage V⁻, V⁺.

The two back-to-back diodes D3, D4 are connected at their cathodes, whereas the corresponding anodes are connected to a respective one of the two scaling capacitances C1 that can be connected or disconnected.

The connection point where the diodes D3, D4 are connected with each other, is connected to a change-over switch 10″ which forms the controlled switching element, allowing the connection point to be connected to either the positive or the negative auxiliary voltage V⁻, V⁺.

Moreover, the anodes of the two scaling capacitances C1 that can be connected or disconnected are connected to ground via an inductance L3, in the same manner as the center tap of the conducting loop L1 of antenna A1.

The connection point of the diodes D3, D4 can be connected to either the positive or the negative auxiliary voltage V⁻, V⁺ via the change-over switch 10″. If a positive auxiliary voltage V⁺ is applied, then both diodes D3, D4 are biased in the reverse direction, because the potential on the cathodes is positive relative to the anodes that are connected to ground via the inductances L3. Because the diodes D3, D4 are reverse-biased and the inductances L3 block high frequencies, the scaling capacitances C1 have no effect on the oscillating circuit of the antenna A1.

Conversely, if the connection point of the diodes D3, D4 is connected by the change-over switch 10″ to the negative auxiliary voltage V⁻, then both diodes D3 and D4 are conducting and the scaling capacitances C1 are added to the capacitance of the oscillating circuit. The oscillating circuit of the antenna can thereby be tuned or detuned by switching the change-over switch 10″.

The antenna A1 can be tuned by measuring the antenna voltage as a function of the stepwise addition of the scaling capacitances C1, until the antenna voltage reaches a maximum value.

The embodiment illustrated in FIG. 5 depicts a symmetric circuit with an antenna A1 grounded at the center, requiring twice the number of scaling capacitances C1, diodes D3 (D4), and inductances L3.

However, an asymmetric circuit that is grounded on one side can also be used, so that only one of each of the components listed above is required.

While the invention has been illustrated and described as embodied in an access control system, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An access control system, comprising:
at least one antenna capable of detecting an access authorization card, said access authorization card including a transponder having a transmit/receive electronics with a carrier frequency;
a control unit connected to the at least one antenna and adapted to evaluate the access authorization card;
wherein the at least one antenna includes controlled switching elements and a conducting loop and an oscillating circuit capacitance, with the conducting loop and the oscillating circuit capacitance forming an oscillating circuit with a resonance frequency that is tuned to the carrier frequency of the transmit/receive electronics, and
wherein the oscillating circuit capacitance comprises a plurality of scaling capacitances which can be stepwise connected to or disconnected from the oscillating circuit capacitance via the controlled switching elements, wherein the controlled switching elements comprise diodes which can be selectively connected to a positive or a negative auxiliary voltage.

2. The access control system of claim 1, further including a change-over switch having a switched contact that can be connected to either the positive or the negative auxiliary voltage, wherein the diodes have an anode and a cathode, with the anode of a first diode being connected to a first scaling capacitance and the anode of a second diode being connected to a second scaling capacitance, and with the cathodes of the first and second diodes being connected back-to-back to one another and to the switched contact, whereby the scaling capacitances can be connected to or disconnected from the oscillating circuit capacitance via the back-to-back connected diodes and the negative and positive auxiliary voltage.

3. The access control system of claim 2, wherein the conducting loop of the at least one antenna includes a center tap that is connected to ground, and further including an additional inductance, with the anodes of the first and second diodes being connected via the additional inductance to ground.

4. The access control system of claim 1, wherein the access authorization card is an RFID transponder.

5. An access control system for at least two access routes, comprising:
an antenna being allocated to each of said access routes and having an antenna terminal, said antenna capable of detecting a presence of a contactless access authorization card in an access route;
a transmit/receive unit connected to each antenna;
a deactivation device connected to each antenna terminal and capable of short-circuiting the antenna, with the deactivation device including two diodes having first diode terminals connected back-to-back at a connection point and second diode terminals connected to the terminal of the antenna;
a control unit connected to the connection point of the diodes, the control unit capable of applying a positive auxiliary voltage or a negative auxiliary voltage or ground to the connection point; and
a control device for evaluating the contactless access authorization card.

6. The access control system of claim 5, wherein the positive auxiliary voltage is greater than an open circuit voltage of the antenna signal.

7. The access control system of claim 5, wherein the access authorization card is an RFID transponder.

8. The access control system of claim 5, wherein the access route is constructed to allow blockage with a controllable barrier that is controlled by the control device.
